(19) United States
(12) Patent Application Publication
(10) Pub. No.: US 2007/0246082 A1
(43) Pub. Date: Oct. 25, 2007

(54) Apparatus for cleaning painting equipment

(75) Inventor: Kenneth Mikalsen, Bryne (NO)

Correspondence Address: VENABLE LLP, P.O. BOX 34385, WASHINGTON, DC, 20043-9998, US

(73) Assignee: ABB AS, Billingstad (NO)

(21) Appl. No.: 11/730,266

(22) Filed: Mar. 30, 2007

(30) Foreign Application Priority Data
Mar. 30, 2006 (EP) 06006684.2

(51) Int. Cl. B08B 3/00; B08B 3/12

(52) U.S. Cl. 134/34; 134/198; 134/94.1; 134/184

(57) ABSTRACT

An apparatus for cleaning one or more parts of an automated painting or coating equipment including a source of gas under pressure, a source of a cleaning agent, a mixer for adding the cleaning agent to the gas, and supplying the cleaning agent to the automated painting or coating equipment. The mixer is adapted to release the cleaning agent into the gas under pressure such that the amount of the cleaning agent released varies with time.

### FIELD OF THE INVENTION

The present invention relates to an apparatus and a method for cleaning automated painting or coating equipment with the aid of a gas under pressure and a cleaning agent. Examples of areas where the present invention can be used are spray paint systems for industrial products, machine parts, appliances, boats or furniture.

The invention is especially useful for spray paint systems that need to change paint color often, one example would be the spray painting of automobile bodies

### TECHNICAL BACKGROUND

One commonly used procedure for cleaning automated painting or coating equipment is described in U.S. Pat. No. 5,072,881, entitled Method of cleaning automated paint spraying equipment.

When changing from one color to another it is necessary to purge the paint supply lines leading to the applicators or spray guns quickly so as to avoid intermixing of the different colors. This purging operation is accomplished by alternately adding set quantities of air and solvent through the supply lines by opening and closing appropriate air and solvent valves. This process is slow and uses a substantial amount of solvent.

To reduce the time required as well as the amount of solvents used in this operation, U.S. Pat. No. 5,072,881 suggests mixing solvent and air via an adjustable ratio mixing valve which then supplies the mixed air and solvent to the supply system.

U.S. Pat. No. 4,881,563, entitled Paint color change system, suggest that between paint color changes, the cleaning solvent is added continuously to the high pressure air in an atomized state and then propelled through the supply line at a high velocity which cleans the supply line thoroughly, permitting a paint color change. It is believed that the improved cleaning occurs because of the finely atomized particles of solvent being carried at high velocity through the supply line and producing a scrub action against the inner walls of the supply line.

### OBJECT AND SUMMARY OF THE INVENTION

An object of a preferred embodiment of the present invention is to provide an improved method and system whereby cleaning time may be reduced, cleaning efficiency may be increased, amount of cleaning medium needed for cleaning automated painting or coating equipment may be reduce and thereby costs are saved.

One or more objects are achieved by time-variable release of a cleaning agent into a gas under pressure which is flowing through, at least, parts of an automated painting or coating system. The time variable adding will create pulses of cleaning agent saturated gas. The gas flow with varying cleaning media saturation and atomized cleaning agent particles cleans the paint color change system, pump, supply line, valve, regulator, applicator or spray gun efficiently.

The time-variable adding of cleaning agent into the coating system or parts of the coating system is produced by a valve means, preferably a rotating disk, with an opening, which interrupts the cleaning agent feed. When the opening in the rotating disk is aligned with the cleaning agent feed, the cleaning agent is for a short time free to flow and is injected into the flushing gas under pressure. When the opening in the disk moves away, by the rotation of the disk, the flow of cleaning agent is interrupted. This creates a time-variable concentration of cleaning agent in the flushing gas.

The frequency of the pulses is controlled the speed of the disk as well as the number of openings in the disk. The dose is dependent on the size of the opening(s) as well as the speed of the disk and the pressure difference between the cleaning agent and the gas under pressure used for flushing the equipment.

The driving force for the rotation of the disk or other valve means may be provided by a turbine in the compressed gas used for flushing the system or by an engine driven by; pressurized air, electric motor or by an actuator.

According to an embodiment of the invention an improved apparatus for cleaning one or more parts of an automated painting or coating equipment is provided, comprising a supply of a first gas under pressure, a supply of a cleaning agent, a mixing means for adding the cleaning agent to the said gas under pressure and supplying it to at least a part of said automated painting or coating equipment wherein said mixing means is adapted to release said cleaning agent into said first gas under pressure such that the amount of said cleaning agent released is variable with time.

According to another embodiment of the invention an improved apparatus for cleaning one or more parts of an automated painting or coating equipment wherein the released amount of said cleaning agent cycles between a maximum flow and a minimum or zero flow.

According to another embodiment of the invention an improved apparatus for cleaning one or more parts of an automated painting or coating equipment wherein the cleaning agent is released as a number of pulses into said first gas under pressure.

According to another embodiment of the invention an improved apparatus for cleaning one or more parts of an automated painting or coating equipment wherein said mixing means comprises a valve means arranged to control the flow and amount of said cleaning agent said first gas under pressure.

According to another embodiment of the invention an improved apparatus for cleaning one or more parts of an automated painting or coating equipment wherein the valve means comprises a rotatable disk provided with at least one opening arranged to turn on or turn off said cleaning agent supply by rotation of the rotatable disk.

According to another embodiment of the invention an improved apparatus for cleaning one or more parts of an automated painting or coating equipment wherein rotation of said rotatable disk is driven by said first gas under pressure or a second gas under pressure.

According to another embodiment of the invention an improved apparatus for cleaning one or more parts of an automated painting or coating equipment wherein the rotational speed of said rotatable disk is arranged variable so as to control the frequency of cleaning agent pulses.

According to another embodiment of the invention an improved method for cleaning one or more parts of an automated painting or coating equipment wherein the amount of said cleaning agent released into said first gas under pressure varies with time.

According to another embodiment of the invention an improved method for cleaning one or more parts of an automated painting or coating equipment wherein the time variant release of said cleaning agent into said stream of gas under pressure is achieved by injecting pulses of cleaning agent.

According to another embodiment of the invention an improved method for cleaning one or more parts of an automated painting or coating equipment wherein flushing or purging at least part of the said automated painting or coating equipment by releasing the said first gas under pressure during a period of time in which the amount of cleaning agent added is zero.

According to another embodiment of the invention an improved method for cleaning one or more parts of an automated painting or coating equipment wherein by beginning or ending a cleaning process by purging the said automated painting or coating equipment with said first gas under pressure without any said cleaning agent.

### BRIEF DESCRIPTION OF THE DRAWINGS

The invention will be elucidated by reference to an embodiment partially illustrated in the drawings.

FIG. 1 illustrates a schematic flow diagram according to an embodiment of the invention;

FIG. 2 illustrates a partial plan of the mixing means according to an embodiment in FIG. 1;

FIG. 3 illustrates a part of the rotation of the rotational disk and the effect on the cleaning agent flow;

FIG. 4 is a flowchart for a method according to an embodiment of the invention; and

FIG. 5 is another flowchart for a method according to another embodiment of the invention.

### DETAILED DESCRIPTION OF THE EMBODIMENTS

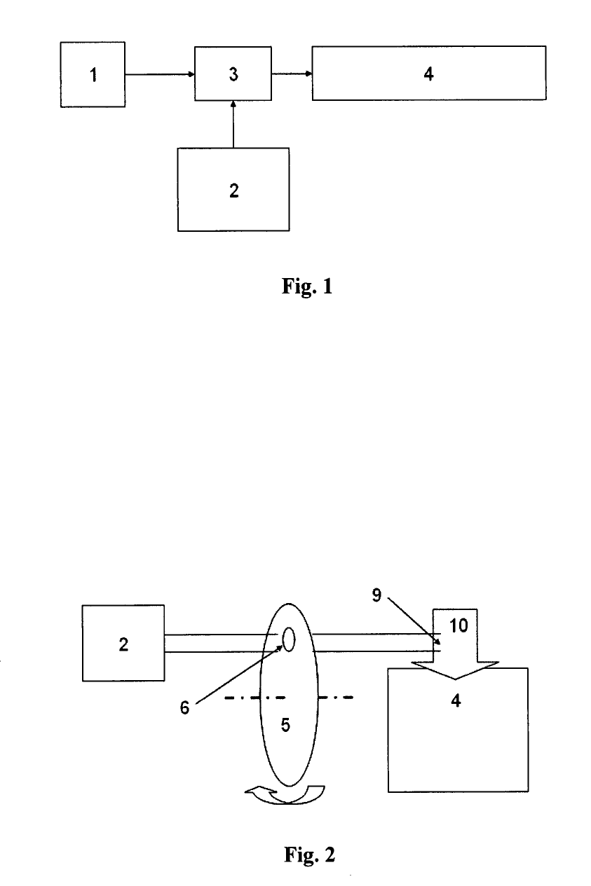

FIG. 1 illustrates a gas supply 1 with gas under pressure which is connected to the mixing means 3. A cleaning agent supply 2 is connected to a mixing means 3. The mixing means 3 doses and releases the cleaning agent from the cleaning agent supply 2 into gas under pressure from the gas supply 1. The gas with time varying amount of cleaning agent is supplied into at least a part of the automated painting or coating equipment 4. The automated painting or coating equipment 4 may be any type of equipment normally found in a painting or coating system such as; paint color change system, pump, supply line, valve, regulator, applicator or spray gun, which needs cleaning.

FIG. 2 illustrates the mixing means 3 where a rotating disk 5 periodically interrupts the cleaning agent from the cleaning agent supply 2. The rotating disk 5 has an opening 6. When the opening 6, due to the rotation of the disk, is aligned with the cleaning agent feed, the cleaning agent flow is no longer interrupted and this allows a short pulse of cleaning agent to be injected into 9 the gas flow 10 which is flushed into at least a part of the automated painting or coating equipment 4.

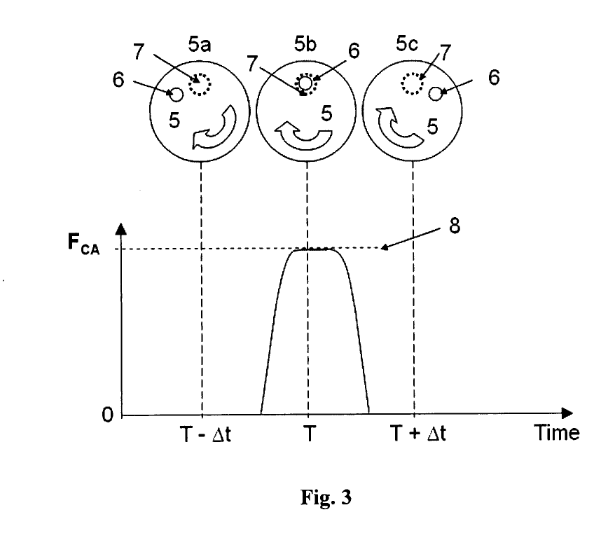

The top part of FIG. 3 illustrates a schematic part of the rotation of the rotational disk. 5a is a snapshot of the disk 5 before the opening 6 in the disk is aligned with the cleaning agent feed 7. 5b is a snapshot of the disk 5 as the opening 6 in the disk is aligned with the cleaning agent feed 7. 5c is a snapshot of the disk 5 after the opening 6 in the disk has moved, due to the rotation of the disk, away from the cleaning agent feed 7 and thereby interrupting the cleaning agent flow.

The lower part of FIG. 3 illustrates how the cleaning agent flow changes with time as the disk 5 rotates. The x-axis represents time and the y-axis represents the flow of cleaning agent F_{CA}. At a time, T−Δt, the disk interrupts the cleaning agent feed (snapshot 5a above illustrates the arrangement of the disk 5, the opening 6 and the feed 7 at the time T−Δt) and the flow of cleaning agent is thus zero.

At a time between T−Δt and T, the opening 6 begins to be aligned with the cleaning agent feed 7 and the flow of cleaning agent begins and starts to increase.

At a time T the opening 6 is perfectly aligned with the cleaning agent feed 7 and the flow of cleaning agent is at a maximum 8 level. As the opening 6 moves away from the cleaning agent feed 7 the flow of cleaning agent starts to decrease. At the time T+Δt, the opening 6 has moved away from the cleaning agent feed 7 and the flow of cleaning agent is interrupted and thus zero. The rotational speed of the disk 5 determines the frequency of the of the time varying release of cleaning agent.

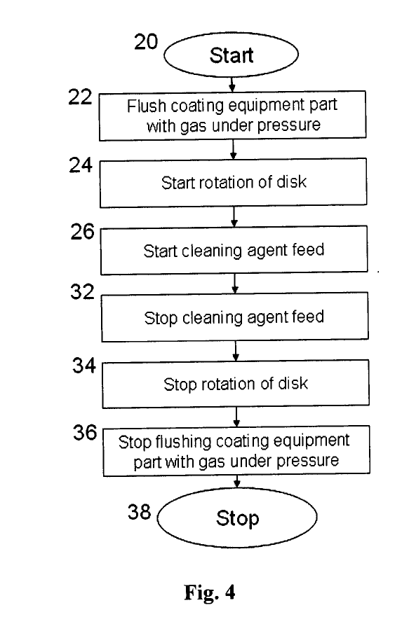

The method of a preferred embodiment is described in FIG. 4 and comprises:

22 the coating equipment is flushed with gas under pressure to purge remaining paint from the equipment (e.g. by turning on a valve in the supply of the first gas under pressure),

24 the disk starts rotating (e.g. by opening a valve in the supply of the second gas under pressure which may drive the disk)

26 the cleaning agent feed starts (e.g. by turning on a valve in cleaning agent feed),

32 the cleaning agent feed is turned off when the cleaning of the coating equipment is finished,

34 the rotation of the disk stops (e.g. by closing the valve for the second gas under pressure which may drive the disk),

36 the flushing of the coating equipment with gas under pressure stops (e.g. by closing the first gas valve),

38 the coating equipment is clean.

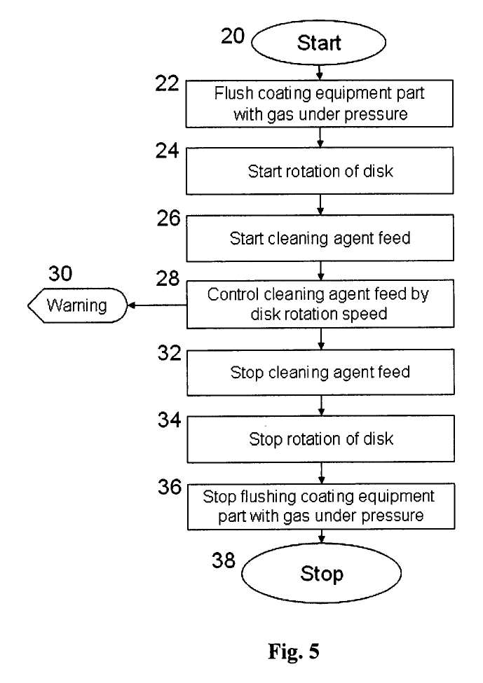

The method of a second embodiment is described in FIG. 5 and comprises:

22 the coating equipment is flushed with gas under pressure to purge remaining paint from the equipment (e.g. by turning on a valve in the supply of the first gas under pressure),

24 the disk starts rotating (e.g. by turning on a valve in the supply of the second gas under pressure which may drive the disk),

26 the cleaning agent feed starts (e.g. by turning on a valve in cleaning agent feed),

28 the speed of the disk (and thus the frequency of pulses) may be controlled by a control loop acting on e.g. the valve for the second gas under pressure,

30 sensors send warning messages to a control system,

32 the cleaning agent feed is turned off when the cleaning of the coating equipment is finished,

34 the rotation of the disk stops (e.g. by closing the valve for the second gas under pressure which drives the disk),

36 the flushing of the coating equipment with gas under pressure stops (e.g. by closing the first gas valve),

38 the coating equipment is clean.

As described in step 30 in the second embodiment of the invention, the apparatus may be equipped with a number of warning systems for incorrect cleaning operation, for example;
if the pressure of the cleaning fluid falls below a predetermined amount, a pressure transducer generates a warning signal
if the flow of cleaning fluid falls below a predetermined volume, a flow meter generates a warning signal
if the disk is not spinning or spinning at the wrong speed, a warning signal is generated.

1. An apparatus for cleaning one or more parts of an automated painting or coating equipment, comprising:
a supply of a first gas under pressure;
a supply of a cleaning agent; and
a mixing means for adding the cleaning agent to the first gas under pressure, and supplying the cleaning agent to at least a part of said automated painting or coating equipment,
wherein during cleaning of the automated painting or coating equipment said mixing means is adapted to release said cleaning agent into said first gas under pressure which is flowing through at least parts of an automated painting or coating system whereby the amount of said cleaning agent released into said first gas under pressure varies with time.

2. The apparatus according to claim 1, wherein the amount of said cleaning agent released into said first gas under pressure cycles between a maximum flow and a minimum flow or zero flow.

3. The apparatus according to claim 1, wherein said cleaning agent is released as a number of pulses into said first gas under pressure.

4. The apparatus according to claim 1, wherein said mixing means comprises a valve means arranged to control the flow and amount of said cleaning agent said first gas under pressure.

5. The apparatus according to claim 4, wherein the valve means comprises a rotatable disk comprising at least one opening arranged to turn on or turn off said supply of cleaning agent by rotation of the rotatable disk.

6. The apparatus according to claim 5, further comprising:
a supply of a second gas under pressure, wherein rotation of said rotatable disk is driven by said first gas under pressure or said second gas under pressure.

7. The apparatus according to claim 6, wherein the first or second gas under pressure is pressurized air.

8. The apparatus according to claim 5, further comprising:
a motor or actuator powered by an energy source other than a gas under pressure, wherein said rotatable disk is driven by the motor or actuator.

9. The apparatus according to claim 5, wherein a rotational speed of said rotatable disk is variable so as to control the frequency of cleaning agent pulses.

10. The apparatus according to claim 4, wherein said mixing means is arranged so that it may be exchanged with another mixing means device.

11. The apparatus according to claim 5, wherein said rotatable disk in said mixing means may be exchangeable.

12. The apparatus according to claim 4, wherein said mixing means comprises two or more valve means with a different valve characteristics.

13. The apparatus according to claim 1, wherein said automated painting or coating equipment comprises any from the group of: paint color change system, pump, supply line, valve, paint dosing apparatus, regulator, applicator and/or spray gun.

14. The apparatus according to claim 1, further comprising:
one or more warning systems selected from the group comprising a pressure transducers generates a warning signal if the pressure of the cleaning agent pressure falls below a predetermined level, a flow meter generates a warning signal if the cleaning fluid flow falls below a predetermined volume, or a motion sensor generates a warning signal if the disk is not spinning or spinning at wrong speed.

15. A method of cleaning one or more parts of an automated painting or coating equipment with an apparatus comprising, a supply of a first gas under pressure, a supply of a cleaning agent, and a mixing means for adding the cleaning agent to the said gas under pressure during cleaning of the automated painting or coating equipment, the method comprising:
flushing at least part of the said automated painting or coating equipment with the first gas under pressure;
adding cleaning agent to said gas under pressure; and
releasing said cleaning agent into said first gas under pressure which is flowing through at least parts of an automated painting or coating system, wherein the amount of said cleaning agent released into said first gas under pressure varies with time.

16. The method according to claim 15, wherein varying the amount of cleaning agent with time comprises cycling a flow of cleaning agent between a maximum flow and a minimum flow into said stream of gas under pressure.

17. The method according to claim 15, wherein varying the amount of cleaning agent with time comprises injecting pulses of cleaning agent.

18. The method according to claim 15, further comprising:
flushing or purging at least part of the said automated painting or coating equipment by releasing said first gas under pressure during a period of time in which an amount of cleaning agent added is zero.

19. The method according to claim 18, further comprising:
beginning or ending a cleaning process by purging said automated painting or coating equipment with said first gas under pressure without any said cleaning agent.

20. The method according to claim 15, wherein said gas under pressure comprises more than 80% nitrogen.

21. The method according to claim 15, wherein said gas under pressure has a relative humidity of less than 50%.

22. The method according to claim 15, wherein said cleaning agent temperature is above 40° C.

23. The method according to claim 16, wherein the amount of cleaning agent released into said first gas under pressure varies with time in cycles with a frequency of 5 Hz to 1000 Hz.

24. The method according to claim 16, wherein the amount of cleaning agent released into said first gas under pressure varies in cycles with a frequency of 10 Hz to 100 Hz.

25. A computer program product, comprising:
a computer readable medium; and
computer program instructions recorded on the computer readable medium and executable by a processor for carrying out a method of cleaning one or more parts of an automated painting or coating equipment with an apparatus comprising, a supply of a first gas under pressure, a supply of a cleaning agent, and a mixing means for adding the cleaning agent to the said gas under pressure during cleaning of the automated painting or coating equipment, the method comprising:
flushing at least part of the said automated painting or coating equipment with the first gas under pressure;
adding cleaning agent to said gas under pressure; and
releasing said cleaning agent into said first gas under pressure which is flowing through at least parts of an automated painting or coating system, wherein the amount of said cleaning agent released into said first gas under pressure varies with time.

26. A system for automated painting or coating equipment, the system comprising:
an apparatus for cleaning at least a part of said automated painting or coating equipment, wherein during cleaning of the automated painting or coating equipment said apparatus comprises mixing means adapted to a time variant release of cleaning agent into a first gas under pressure which is flowing through, at least, parts of an automated painting or coating system for cleaning a part of said equipment.
